(19) United States
(12) Patent Application Publication
(10) Pub. No.: US 2026/0095559 A1
(43) Pub. Date: Apr. 2, 2026

(54) LIGHTING AND IMAGING SYSTEM

(71) Applicant: Gentex Corporation, Zeeland, MI (US)

(72) Inventors: Brian J. Katerberg, Zeeland, MI (US); Zachary L. Tsang, Holland, MI (US); Cymbre O. Spoehr, Zeeland, MI (US); Alistair J. Baxter, East Kilbride (GB); Renato Araujo Oliveira Filho, Jaboatao dos Guararapes (BR)

(73) Assignee: Gentex Corporation, Zeeland, MI (US)

(21) Appl. No.: 19/345,019

(22) Filed: Sep. 30, 2025

Related U.S. Application Data
(60) Provisional application No. 63/701,744, filed on Oct. 1, 2024.

(51) Int. Cl. H04N 13/122; G01S 17/894; G06F 3/01; H04N 13/207; H04N 13/254

(52) U.S. Cl. CPC H04N 13/122; G01S 17/894; G06F 3/017; H04N 13/207; H04N 13/254

(57) ABSTRACT

An imaging system includes a first three-dimensional (“3D”) imager module and at least one two-dimensional (“2D”) imager module. The first 3D imager module is configured to be located in a first position to capture a first 3D depth information from a first region of an environment. The at least one 2D imager module is configured to be oriented to capture a 2D image of the first region of the environment corresponding to the first 3D depth information. An actuator is configured to orient a lighting or vision component between different orientations around the environment. A control system is configured to, identify, in the 2D image, an area of interest within the first region of the environment, and generate an instruction to automatically orient the light or vision component towards a measured depth of the area of interest.

### CROSS-REFERENCE TO RELATED APPLICATION

This application claims priority to and the benefit under 35 U.S.C. § 119(e) of U.S. Provisional Application No. 63/701,744, filed on Oct. 1, 2024, entitled “MEDICAL LIGHTING IMAGING SYSTEM,” the disclosure of which is hereby incorporated herein by reference in its entirety.

### FIELD OF THE DISCLOSURE

The present disclosure generally relates to an imaging system and, more particularly, an imaging system that utilizes at least one 3D imager module and a 2D imager module oriented to capture a 2D image overlapping a 3D depth information captured by the 3D imager module for a variety of applications.

### SUMMARY OF THE DISCLOSURE

According to one aspect of the present disclosure, an imaging system includes a first three-dimensional (“3D”) imager module and at least one two-dimensional (“2D”) imager module. The first 3D imager module is configured to be located in a first position to capture a first 3D depth information from a first region of an environment. The at least one 2D imager module is configured to be oriented to capture a 2D image of the first region of the environment corresponding to the first 3D depth information. An actuator is configured to orient a lighting or vision component between different orientations around the environment. A control system is configured to, identify, in the 2D image, an area of interest within the first region of the environment, and generate an instruction to automatically orient the light or vision component towards a measured depth of the area of the interest.

According to another aspect of the present disclosure, an imaging system includes a first three-dimensional (“3D”) imager module configured to be located in a first position to capture a first 3D depth information from a first region of an environment, and a second 3D imager module configured to be located in a second location to capture a second 3D depth information from a second region of the environment that partially overlaps the first region at an overlapping region. At least one two-dimensional (“2D”) imager module is configured to be oriented to capture a 2D image of the first and second regions of the environment corresponding to the first and second 3D depth information. A control system is configured to match features of the environment in the first and second 3D depth information within the overlapping region, and stitch the first and second 3D depth information of the first and second regions to create a 3D point cloud of the first and second regions of the environment.

According to yet another aspect of the present disclosure, an imaging system includes a first three-dimensional (“3D”) imager module and at least one two-dimensional (“2D”) imager module. The first 3D imager module is configured to be located in a first position to capture a first 3D depth information from a first region of an environment. The at least one 2D imager module is configured to be oriented to capture a 2D image of the first region of the environment corresponding to the first 3D depth information. An actuator is configured to orient a lighting or vision component between different orientations around the environment. A control system is configured to identify an object in the environment and correspond the object to an area of interest of the environment, and generate an instruction to automatically orient the light or vision component towards a measured depth of the area of interest.

The present disclosure generally provides to an imaging system that utilizes at least one 3D imager module and a 2D imager module oriented to capture a 2D image overlapping a 3D depth information captured by the 3D imager module for a variety of applications. The overlapping images may be used to illuminate a region of interest with desirable and optimal orientation or illumination characteristics. Traditional systems that utilize both imaging and illumination components typically include only 2D images or 3D images. When more than one image is captured from two different orientations, a relative positional difference between the orientations can cause distortion and prevent obtaining an accurate understanding of an object being imaged. The imaging system improves upon these shortcomings by accurately overlapping the 2D and 3D images.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective, partially schematic view of an imaging system, according to an aspect of the present disclosure;

FIG. 2 is a perspective view of a 3D point cloud and implementation of an imaging system, according to an aspect of the present disclosure;

FIG. 3 is a schematic view of a vision assembly for an imaging system, according to an aspect of the present disclosure;

FIG. 4 is a schematic view of a three-dimensional imager module, according to an aspect of the present disclosure; and

FIG. 5 is a schematic view of a control system for an imaging system, according to an aspect of the present disclosure.

### DETAILED DESCRIPTION

The present illustrated embodiments reside primarily in combinations of method steps and apparatus components related to an imaging system that utilizes at least one 3D imager module and a 2D imager module oriented to capture a 2D image overlapping a 3D depth information captured by the 3D imager module. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

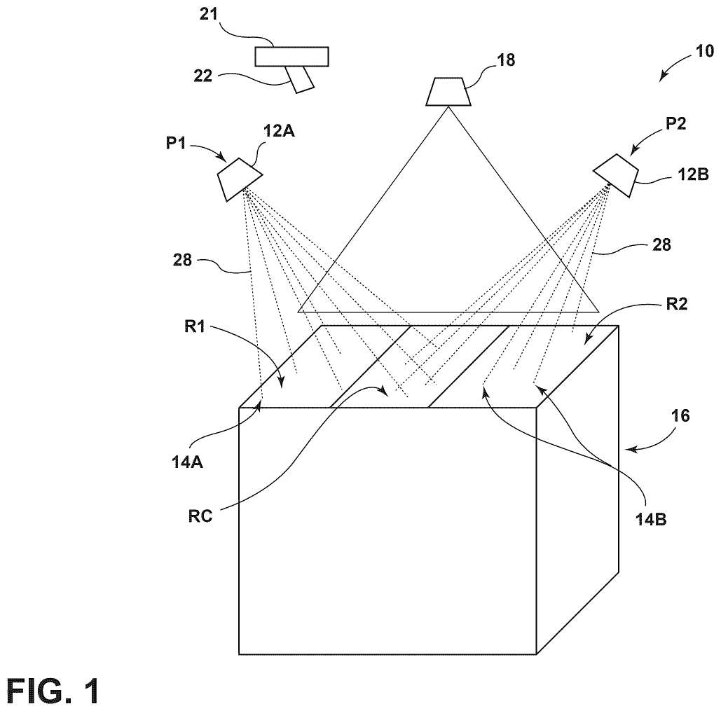

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring initially to FIGS. 1-3, reference numeral 10 generally designates an imaging system. The imaging system 10 includes a first three-dimensional (“3D”) imager module 12A that is configured to be located in a first position P1 to capture a first 3D depth information 14A from a first region R1 of an environment 16. At least one two-dimensional (2D) imager module 18 is configured to be oriented to capture a 2D image 20 of the first region R1 of the environment 16 corresponding to the first 3D depth information 14A. An actuator 21 is configured to orient a lighting or vision component 22 between different orientations around the environment 16. A control system 100 is configured to identify in the 2D image 20, an area of interest “AoI” within the first region R1 of the environment 16, and generate an instruction to automatically orient the light or vision component 22 towards a measured depth of the area of interest.

As depicted, the imaging system 10 may further include a second 3D imager module 12B that is configured to be located in a second location P2 to capture a second 3D depth information 14B from a second region R2 of the environment 16 that is different than the first region R1. Further, the imaging system 10 may utilize a plurality of additional 3D imager modules 12C-12N (e.g., for a total of three or more, four or more, five or more, ten or more, fifteen or more, twenty or more, fifty or more, one hundred or more, two hundred or more) from a plurality of additional positions P3-PN to capture a plurality of additional 3D depth information 14C-14N of various regions 14C-14N of the environment 16 that are different than the first and second regions R1, R2. Likewise, the at least one 2D imager module 18 may include a plurality of additional 2D imager modules necessary to capture the regions R1-RN. It should be appreciated that the number of 2D imager modules 18 may be equal to, more than, or less than the number of 3D imager modules 12A-12N. In some implementations, the number of 2D imager modules 18 may be less than the number of 3D imager modules 12A-12N at a ratio of 1:2, 1:3, 1:4, or more. Generally speaking, the 3D imager modules 12A-12N may have a limited field of view in view of manufacturing constraints, while the at least one 2D imager module 18 can be configured for a larger field of view (e.g., to cover more than one region R1-RN). In this manner, a single one of the 2D images 20 can be utilized to, for example, select the area of interest AoI from multiple regions R1-RN captured by two or more of the 3D imager modules 12A-12N in order to orient the lighting or vision component 22.

The imaging system 10 may be useful for a variety of environments in addition to the depicted environment 16. For example, the imaging system 10 may be beneficial in any scenario where it is beneficial to accurately obtain positional depth and other 3D structural information when, for example, orienting (e.g., aiming, focusing, etc.) the lighting or vision component 22 in 3D space along the X, Y, and/or Z-axis. Therefore, the imaging system 10 may be useful in accurately collecting 3D information on buildings, structures, and objects, including, for example, persons, work surfaces, vehicles and/or the like. The imaging system 10 may, for example, be beneficial for providing lighting in facilities, such as medical facilities (e.g., operating tables and patients), capturing images or video (e.g., via orientation, focusing, or calibration) of vehicles, and/or persons (e.g., in entertainment environments, working environments, manufacturing environments, sporting events, combinations thereof, and/or the like). As such, unless otherwise explicitly stated, the term environment 16 as used herein may refer to a person (e.g., athlete, patient, or other person), place (e.g., an operating room, a building, an office, a road, or other location), or thing (e.g., a workpiece, a tool, the interior of a vehicle, or other element). Likewise, the “imaging system” may otherwise be referred to as a map imaging system, a medical imaging system, a sport event imaging system, an athlete tracking imaging system, a facility imaging system, an architecture imaging system, a workpiece tracking imaging system, the like, and/or combinations thereof. In some implementations, the depth, and other 3D structural information may be utilized (e.g., via stitching the first 3D depth information 14A and the second 3D depth information 14B) to create a 3D point cloud 24. More particularly, the control system 100 may be further configured to utilize the first and second 3D depth information of the first and second regions 14A, 14B to create the 3D point cloud 24 of the environment 16. The 3D point cloud 24 may be digital or provided as a template that can be utilized for building a physical 2D or 3D model (e.g., a 3D cut-and-fold or 2D printing template). As will be described in greater detail below, when digital, the 3D point cloud 24 may be interactable and/or otherwise utilized in conjunction with the 2D image 20. In addition, when digital, the 3D point cloud 24 may be interactable and utilized for machining, assembling, or printing 3D objects.

The imaging system 10 (e.g., the control system 100) may be configured to review the environment 16 captured in the first 3D depth information 14A and the second 3D depth information 14B (e.g., and additional 3D depth information 14C-14N of the other regions R3-RN from additional 3D imager modules 12C-12N) for matching features and utilizing the matching features to create the 3D point cloud 24 of the environment 16. The matching features may, for example, be portions of buildings, facilities, structures, or objects within the environment, such as medical devices, portions of a patient, work surfaces, and/or the like. More particularly, the matching features may be detected as overlapping when the first and second 3D depth information 14A-14B (e.g., contours of the environment 16) are matched in a common or overlapping region “RC.” In some implementations, the RC may include a plurality of RCs based on the number of 3D imager modules 12A-12N and regions R1-RN. Further, the imaging system 10 (e.g., the control system 100) may be configured to determine a spatial relationship (e.g., along the X, Y, and/or Z-axis) between the lighting or vision component 22 and the environment 16 (e.g., the distance between the lighting or vision component 22 and the environment 16) captured in the 2D image 18.

The imaging system 10 (e.g., the control system 100) may utilize the spatial relationship to determine an environmental scale and/or respective position in the 2D imager module 18 (e.g., an absolute size obtained via the 3D point cloud 24). Based on the environmental scale and/or respective position, the imaging system 10 (e.g., the control system 100) may orient (e.g., aim, focus, etc.) the lighting or vision component 22 along the X, Y, and/or Z-axis. In this manner, different angles and orientations captured in the 3D depth information 14A-14N of the regions R1-RN can be determined for improvements in scaling the 3D point cloud 24.

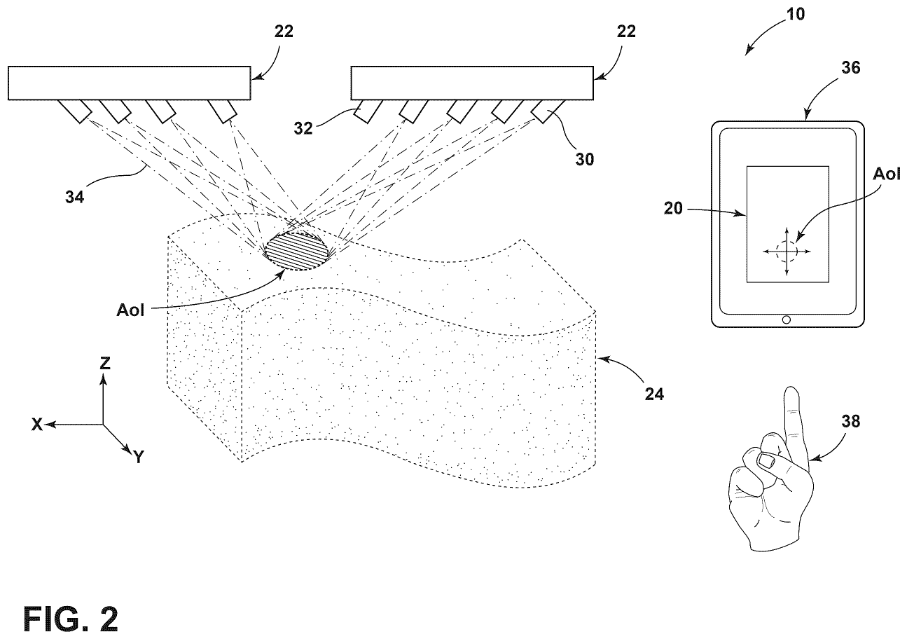

With reference now to FIGS. 2-4, the at least one 2D imager module 18 may be configured as red, green, blue (“RGB”) cameras, other types of cameras configured to capture images within the visible spectrum, other types of cameras configured to capture images within the infrared spectrum, and/or other types of cameras configured to capture 2D information. The first and second 3D imager modules 12A, 12B (e.g., and additional 3D imager modules 12C-12N) may, on the other hand, include a structured light camera 25 and an illuminator 26 configured to project a structured light 28. In this manner, the imaging system 10 (e.g., the control system 100) may be configured to determine the depth and other spatial, locational, and orientational relationships described herein by utilizing the structured light 28.

Under the principles of structured light, the control system 100 may be configured to obtain depth information based on the principles of triangulation and known geometries between the structured light camera 25, the illuminator 26, and the distribution of an array of spots, dots, or other patterns resulting in the environment 16 from the structured light 28. Under the principles of structured light, the 3D information (e.g., depth information) can be obtained in absolute scale. More particularly, the illuminator 26 may include at least one laser diode or a plurality of laser diodes with one or more collimation or diffractive elements to guide and control the projection of the structured light 28. The 3D imager module 12A-12N and the illuminator 26 may be closely and rigidly fixed on a common optical bench structure (e.g., within a common or multi-piece 3D camera housing) and, based on the known spacing between the 3D imager module 12A-12N and the illuminator 26 (e.g., the laser diodes) and distribution of the structured light 28, the light spot is reflected from the environment 16 and captured along an epipolar line by the 3D imager modules 12A-12N, which, in turn, can be triangulated to extract a depth (e.g., depth information 14A-14N) of the environment 16 and 3D imager modules 12A-12N. The depth at each light spot can then be used to extrapolate the 2D point cloud 24, such as the relative positions, locations, and orientations of the environment 16. Likewise, changes in depth can be used to extrapolate relative movements of the environment 16.

In some implementations, the imaging system 10 may operate under other principles to obtain 3D information, such as the principles of Time-of-Flight. More particularly, the illuminator 26 may be configured to emit the structured light 28 substantially within the infrared spectrum and the 3D imager module 12A-12N may be configured to capture the structured light 28 reflected from the environment 16 and calculate the time that it takes the emission to be projected from the illuminator 26 and captured by the camera 25. In still other implementations, the imaging system 10 may utilize stereovision or other technologies for capturing 3D information.

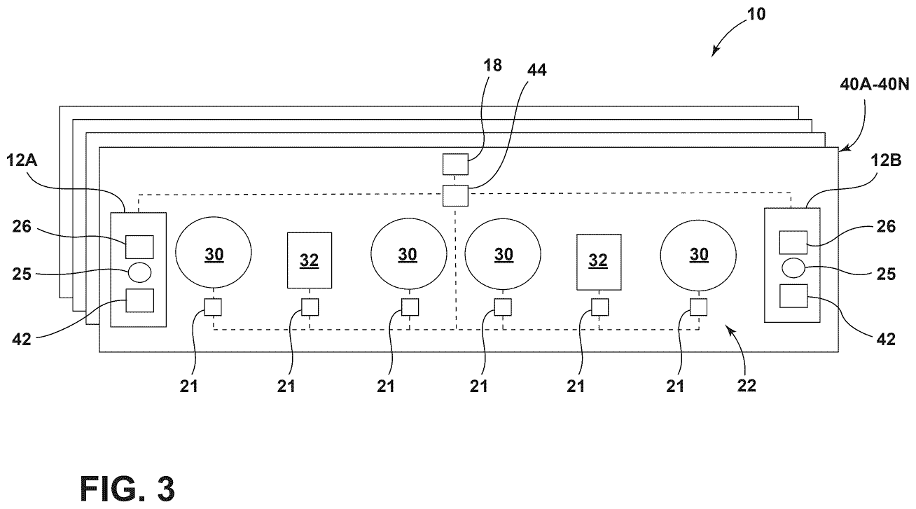

With particular reference to FIGS. 2 and 3, the lighting or vision component 22 may include one or more lights 30, one or more cameras 32, or both one or more lights 30 and cameras 32. For example, the lighting or vision component 22 may include a plurality of both lights 30 and cameras 32 (e.g., for a total of three or more, four or more, five or more, ten or more, fifteen or more, twenty or more, fifty or more, one hundred or more, two hundred or more). The lights 30 and cameras 32 may include lens elements for focusing the light 30 or camera 32 to the various depths of the AoI determined in the depth information 14A-14N. For example, the lens element in the lights 30 may be utilized for modifying an illumination angle by converging or diverging a light 34 generated by the lights 30. The lights 30 may be in the visible or non-visible (e.g., infrared) spectrum. The lens element in the camera 32 may be utilized for changing a field of view and/or focusing to the various depths. The actuator 21 (e.g., a gimbal) may be configured to rotate, tilt, and/or otherwise orient the lights 30 and cameras 32 towards the AoI along one, two, or three of the axes X, Y, and Z. The actuator 21 may include a plurality of actuators 21 associated with different ones of the lights 30 and/or cameras 32 or otherwise configured to move each light 30 and camera 32 individually.

The imaging system 10 may be configured to operate under one or more operating schemes. For example, a display 36 (e.g., a tablet, computer, phone, a VR or semi-VR headset, and/or other computing device) may display the 2D image 20 in an interactable digital medium. For example, as best depicted in FIG. 2, a user of the imaging system 10 may (as facilitated by the control system 100), generate the 2D image 20 on the display 36 and select (e.g., via touch inputs, a mouse, and/or the like) the AoI in the environment 16 that needs to be provided with the light 30 or captured by cameras 32. Once the AoI is selected, the control system 100 may generate the instruction to automatically orient the light or vision component 22 towards the measured depth of the AoI. In another operating scheme that may be utilized alternatively or in conjunction with the display 36, the imaging system 10 may be configured to identify an object 38, depicted as an operator's hand, that is associated with the AoI. For example, the control system 100 may be configured to identify a hand gesture before associating the operator's hand with the AoI. The object 38 may otherwise be associated with a tool, wand, remote, or other element that includes an identifiable shape and size. The object 38 may have high infrared contrast (e.g., exhibiting high or low reflectivity). In this manner, the control system 100 may generate the instruction to automatically orient the light or vision component 22 towards the measured depth of the object 38 or the AoI located under the object 38. Object 38 identification and recognition may be beneficial in scenarios, such as medical working environments, where it can be difficult to have to manually control the location of the lights during a procedure. In some embodiments, the object 38 is only recognized or otherwise tracked when it is contained in one or more specific regions R1-RN to, for example, a patient, an operation, and/or the like. The object 38 identification and recognition may be beneficial in other scenarios as well, such as tracking vehicles, persons (e.g., in entertainment environments, working environments, manufacturing environments, combinations thereof, and/or the like). Indeed, the control system 100 may be utilized for identifying and recognizing any object 38 and associating it with the AoI. In some implementations, the control system 100 may identify an obstruction between some of the lights 30 or cameras 32 and the AoI. In this manner, the control system 100 may be configured to identify other ones of the lights 30 or cameras 32 without obstructions and utilize those unobstructed ones of the lights 30 or cameras 32 for the functions, methods, and operations described herein.

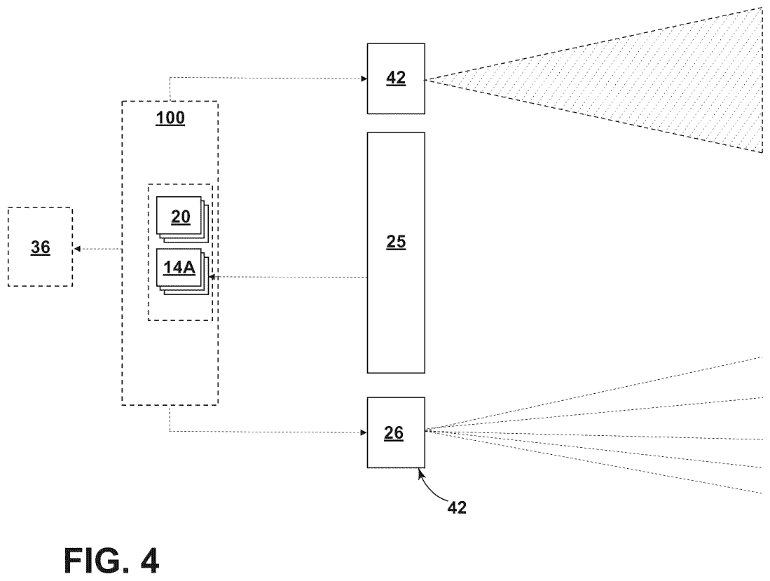

As best illustrated in FIG. 4, the 3D imager modules 14A-14N, the 2D imager modules 18, the actuator 21, and the lighting or vision component 22 be located in, connected, or otherwise coupled to a common housing 40A-40N located in the environment 16. Further, a plurality of common housings 40A-40N may be utilized in and around the environment 16 that each includes some of the 3D imager modules 14A-14N, the 2D imager modules 18, the actuator 21, and the lighting or vision component 22. In some embodiments, an infrared flood illuminator 42 may further be located in each common housing 40A-40N. The infrared flood illuminator 42 may, for example, be utilized with the object 38. More particularly, the object 38 may include a wand, a bracelet, a different wearable object, a sticker on a work tool or elsewhere, and the like that is configured to reflect infrared light that is in turn, captured by the 3D imager modules 14A-14N for enhanced identification and recognition. The flood illuminator 42 may be sequenced or pulsed between pulses of the structured light 28 from the illuminator 26. Further, a communication module 44 may be located in the common housing 40A-40N, otherwise in communication with each or select ones of the 3D imager modules 14A-14N, the 2D imager modules 18, the actuator 21, the lighting or vision component 22, the display 36, and the infrared flood illuminator 42. Further, it should be appreciated that components of the imaging system 10 may be located in different housings. For example, the lights 30 and/or cameras 32 may be located in one housing while the imager modules 12A, 12B, and 18 may be located in a separate housing. In other words, unless explicitly stated, the components of the imaging system 10 may be located in the same or different housings in any combination.

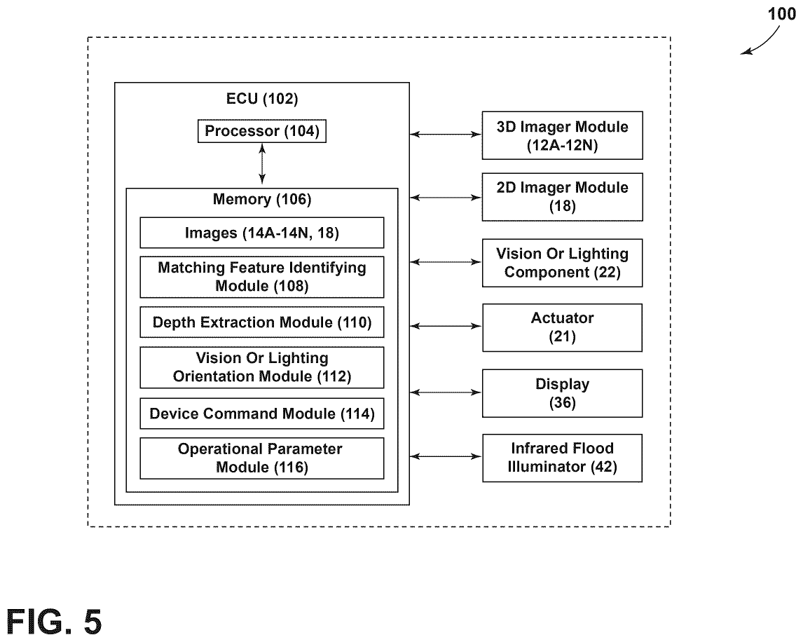

With reference now to FIG. 5, the control system 100 may include at least one electronic control unit (ECU) 102. The at least one ECU 102 may be located in or otherwise in communication with one or more of the 3D imager modules 14A-14N, the 2D imager modules 18, the actuator 21, the lighting or vision component 22, the display 36, and the infrared flood illuminator 42. The control system 100 may be located fully or partially within one, more, or each of the common housing 40A-40N, local to the environment 16, or remote from the environment 16. The at least one ECU 102 may include a processor 104 and a memory 106. The processor 104 may include any suitable processor 104. Additionally, or alternatively, each ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid state) memory, or the like. The memory 106 may include Random Access Memory (RAM), a Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the imaging system 10. The 3D imager modules 14A-14N, the 2D imager modules 18, the actuator 21, the lighting or vision component 22, the display 36, and the infrared flood illuminator 42 may, therefore, be controlled by the control system 100.

With continued reference to FIG. 5, the memory 106 may include a series of the 3D depth information 14A-14N of the environment 16 (e.g., the AoI) and the 2D images 20. The memory 106 may further include a matching feature identifying module 108 (e.g., containing instructions for detecting matching features), a depth extraction module 110 (e.g., containing instructions for extracting depth, the relative positions, locations, and orientations of the environment 16 captured in the 3D imager modules 12A-12N), a vision or lighting orientation module 112 (e.g., for detecting the position and orientation of the lights 30 and camera 32), a device command module 114 (e.g., for focusing, with the lens element, moving or orienting, with the actuator 21, the lights 30 and camera 32), and an operational parameter module 116 (e.g., for generating the 3D point cloud, object recognition, obstruction identification).

The disclosure herein is further summarized in the following paragraphs and is further characterized by combinations of any and all of the various aspects described therein.

According to one aspect of the present disclosure, an imaging system includes a first three-dimensional (“3D”) imager module and at least one two-dimensional (“2D”) imager module. The first 3D imager module is configured to be located in a first position to capture a first 3D depth information from a first region of an environment. The at least one 2D imager module is configured to be oriented to capture a 2D image of the first region of the environment corresponding to the first 3D depth information. An actuator is configured to orient a lighting or vision component between different orientations around the environment. A control system is configured to, identify, in the 2D image, an area of interest within the first region of the environment, and generate an instruction to automatically orient the light or vision component towards a measured depth of the area of interest.

According to another aspect, an imaging system includes a second 3D imager module configured to be located in a second location to capture a second 3D depth information from a second region of the environment.

According to yet another aspect, the at least one 2D imager is oriented to capture both the first and second regions in the 2D image.

According to still another aspect, the first region and the second region overlap.

According to another aspect, the control system is further configured to stitch the first and second 3D depth information of the first and second regions to create a 3D point cloud of the first and second regions of the environment.

According to still yet another aspect, an imaging system includes a plurality of additional 3D imager modules from a plurality of additional positions to capture a plurality of additional 3D depth information from a plurality of additional regions of the environment that is different than the first and second regions.

According to another aspect, at least one 2D imager module includes two or more imager modules that, in combination, are configured to capture the first, second, and additional regions in the 2D images.

According to yet another aspect, at least one 2D imager module is configured as an RGB camera.

According to another aspect, a first 3D imager module includes an illuminator configured to project structured light.

According to still another aspect, a control system is configured to determine a relative spatial dimension under the principles of Time-of-Flight.

According to still yet another aspect, the imaging system includes a display generating the 2D image and the control system is configured to receive a user input selecting the area of interest from a user.

According to another aspect, the control system is configured to identify an object in the environment corresponding to the area of interest.

According to still yet another aspect, an imaging system includes an infrared flood illuminator, wherein the object is formed of a material having high infrared contrast.

According to yet another aspect, the object is associated with a gesture of a user's hand.

According to another aspect of the present disclosure, an imaging system includes a first three-dimensional (“3D”) imager module configured to be located in a first position to capture a first 3D depth information from a first region of an environment, and a second 3D imager module configured to be located in a second location to capture a second 3D depth information from a second region of the environment that partially overlaps the first region at an overlapping region. At least one two-dimensional (“2D”) imager module is configured to be oriented to capture a 2D image of the first and second regions of the environment corresponding to the first and second 3D depth information. A control system is configured to match features of the environment in the first and second 3D depth information within the overlapping region, and stitch the first and second 3D depth information of the first and second regions to create a 3D point cloud of the first and second regions of the environment.

According to still another aspect, an imaging system further includes an actuator is configured to orient a lighting or vision component between different orientations around the environment.

According to yet another aspect, a control system is configured to identify, in the 2D image, an area of interest within the first region of the environment, and generate an instruction to automatically orient the light or vision component towards a measured depth of the area of interest.

According to still yet another aspect, a control system is configured to identify an object in the environment and correspond the object to an area of interest of the environment, and generate an instruction to automatically orient the light or vision component towards a measured depth of the area of interest.

According to yet another aspect of the present disclosure, an imaging system includes a first three-dimensional (“3D”) imager module and at least one two-dimensional (“2D”) imager module. The first 3D imager module is configured to be located in a first position to capture a first 3D depth information from a first region of an environment. The at least one 2D imager module is configured to be oriented to capture a 2D image of the first region of the environment corresponding to the first 3D depth information. An actuator is configured to orient a lighting or vision component between different orientations around the environment. A control system is configured to identify an object in the environment and correspond the object to an area of interest of the environment, and generate an instruction to automatically orient the light or vision component towards a measured depth of the area of interest.

According to still another aspect, an imaging system includes an infrared flood illuminator, wherein the object is formed of a material having high infrared contrast.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. An imaging system comprising:
a first three-dimensional (“3D”) imager module configured to be located in a first position to capture a first 3D depth information from a first region of an environment;
at least one two-dimensional (“2D”) imager module configured to be oriented to capture a 2D image of the first region of the environment corresponding to the first 3D depth information;
an actuator is configured to orient a lighting or vision component between different orientations around the environment; and
a control system configured to:
identify, in the 2D image, an area of interest within the first region of the environment; and
generate an instruction to automatically orient the light or vision component towards a measured depth of the area of interest.

2. The imaging system of claim 1, further including a second 3D imager module configured to be located in a second location to capture a second 3D depth information from a second region of the environment.

3. The imaging system of claim 2, wherein the at least one 2D imager is oriented to capture both the first and second regions in the 2D image.

4. The imaging system of claim 3, wherein the first region and the second region overlap.

5. The imaging system of claim 4, wherein the control system is further configured to stitch the first and second 3D depth information of the first and second regions to create a 3D point cloud of the first and second regions of the environment.

6. The imaging system of claim 2, further including a plurality of additional 3D imager modules from a plurality of additional positions to capture a plurality of additional 3D depth information from a plurality of additional regions of the environment that are different than the first and second regions.

7. The imaging system of claim 6, wherein the at least one 2D imager module includes two or more imager modules that, in combination, are configured to capture the first, second, and additional regions in the 2D images.

8. The imaging system of claim 1, wherein the at least one 2D imager module is configured as an RGB camera.

9. The imaging system of claim 8, wherein the first 3D imager module includes an illuminator configured to project structured light.

10. The imaging system of claim 8, wherein the control system is configured to determine the first depth information under the principles of Time-of-Flight.

11. The imaging system of claim 1, further including a display generating the 2D image and the control system is configured to receive a user input selecting the area of interest from a user.

12. The imaging system of claim 1, wherein the control system is configured to identify an object in the environment corresponding to the area of interest.

13. The imaging system of claim 12, further including an infrared flood illuminator, wherein the object is formed of a material having high infrared contrast.

14. The imaging system of claim 12, wherein the object is associated with a gesture of a user's hand.

15. An imaging system comprising:
a first three-dimensional (“3D”) imager module configured to be located in a first position to capture a first 3D depth information from a first region of an environment;
a second 3D imager module configured to be located in a second location to capture a second 3D depth information from a second region of the environment that partially overlaps the first region at an overlapping region;
at least one two-dimensional (“2D”) imager module configured to be oriented to capture a 2D image of the first and second regions of the environment corresponding to the first and second 3D depth information; and
a control system configured to:
match features of the environment in the first and second 3D depth information within the overlapping region; and
stitch the first and second 3D depth information of the first and second regions to create a 3D point cloud of the first and second regions of the environment.

16. The imaging system of claim 15, further including an actuator is configured to orient a lighting or vision component between different orientations around the environment.

17. The imaging system of claim 16, wherein the control system is further configured to:
identify, in the 2D image, an area of interest within the first region of the environment; and
generate an instruction to automatically orient the light or vision component towards a measured depth of the area of interest.

18. The imaging system of claim 16, wherein the control system is further configured to:
identify an object in the environment and correspond the object to an area of interest of the environment; and
generate an instruction to automatically orient the light or vision component towards a measured depth of the area of interest.

19. An imaging system comprising:
a first three-dimensional (“3D”) imager module configured to be located in a first position to capture a first 3D depth information from a first region of an environment;
at least one two-dimensional (“2D”) imager module configured to be oriented to capture a 2D image of the first region of the environment corresponding to the first 3D depth information;
an actuator is configured to orient a lighting or vision component between different orientations around the environment; and
a control system configured to:
identify an object in the environment and correspond the object to an area of interest of the environment; and
generate an instruction to automatically orient the light or vision component towards a measured depth of the area of interest.

20. The imaging system of claim 19, further including an infrared flood illuminator, wherein the object is formed of a material having high infrared contrast.
